(19) United States
(12) Patent Application Publication
(10) Pub. No.: US 2004/0122967 A1
(43) Pub. Date: Jun. 24, 2004

(54) Method and apparatus for managing packet flows for multiple network services

(76) Inventors: Robert D. Bressler, Helena, CA (US); Christoph L. Schuba, Sandhausen (DE); Michael F. Speer, Mountain View, CA (US)

Correspondence Address: PARK, VAUGHAN & FLEMING LLP, 508 SECOND STREET, SUITE 201, DAVIS, CA, 95616, US

(21) Appl. No.: 10/329,016

(22) Filed: Dec. 23, 2002

(51) Int. Cl. G06F 15/16

(52) U.S. Cl. 709/232

(57) ABSTRACT

One embodiment of the present invention provides a system that facilitates managing network data traffic for multiple network services. During operation, the system receives flow rules for network data traffic from multiple network services, wherein the flow rules can possibly conflict. Next, the system collapses the flow rules from the multiple network services into a consistent set of flow rules in a low-level form that can be efficiently applied to a packet flow. The system subsequently installs the consistent set of flow rules into a flow enforcement device, which applies the consistent set of flow rules to a packet flow received from a high-speed network connection. In this way, the flow rules from the multiple network services can be simultaneously applied to packet flow, instead of being applied separately by each network service.

### BACKGROUND

1. Field of the Invention

The present invention relates to the task of managing packet flows across a computer network. More specifically, the present invention relates to a method and an apparatus that simultaneously manages packet flows for multiple network services.

2. Related Art

Dramatic advances in networking technology presently make it possible the transfer data at bandwidths exceeding 2.5 gigabits per second across a single high-speed optical pipe. These high-speed optical pipes can be used to connect data centers to wide area networks and the Internet. In order to effectively use the bandwidth available through these high-speed optical pipes, edge devices within the data centers must be able to manage the packet flows received through these pipes. For example, an edge device can perform a number of operations related to managing network flows, such as performing firewall functions, service level agreement (SLA) monitoring, transport matching and load balancing. Performing these operations can be an extremely challenging task because the packet flows need to be managed as they are received at high transfer rates.

These operations are typically applied to packet flows in pipelined fashion. For example, referring to FIG. 1, a packet flow received through high-speed pipe 102 feeds through a pipeline that includes a number of separate modules, including a firewall module 104, an SLA monitoring module 105, a transport matching module 106 and a load-balancing module 107. The output of this pipeline feeds through a switch 108, which switches packets to various servers 110-112 within the data center. This pipelined architecture allows the modules to operate sequentially on the packet flow. However, passing the packet flow through multiple pipeline stages increases latency, which can adversely affect performance for many applications.

Note that each of these pipeline modules can conceptually be divided into three components: (1) a classifier and dispatch component; (2) a module-specific component that directly operates on the packets in the packet flow; and (3) a management and administration component that generates rules for the classifier and dispatch component. (Note that the classifier and dispatch component and the module-specific component are collectively referred to as the “data plane,” whereas the management and administration component is referred to as the “control plane”). In this way, the high-speed classification and dispatch operations performed by the data plane can be separated from the management and administration functions performed by the control plane. FIG. 2 illustrates how the modules in FIG. 1 can be separated into separate control plane and data plane modules.

A standardized interface is being developed to facilitate this separation. In particular, see the paper entitled “Open Standards for the Control and Forwarding Planes in Network Elements,” by Lily L. Yang, Ram Gopal and Susan Hares, which defines a standardized interface between the control and forwarding planes. This standardized interface allows system vendors to use components from different suppliers to perform these control and forwarding functions.

In order to provide additional performance, a number of pipelines can operate in parallel. For example, referring to FIG. 3, the packet flow from high-speed pipe 102 is routed into three parallel pipelines by fan out module 300. The outputs of these pipelines feed into switch 108, which switches packets from the pipelines to various servers 110-112 within the data center.

Providing parallel pipelines can improve performance if the packet stream can be divided into separate flows for the different pipelines. However, it does not help if the packet stream contains only a single flow. Moreover, this technique does not reduce the number of pipeline stages, and consequently does little to reduce latency.

Hence, what is needed is a method and an apparatus that facilitates managing packet flows received from a high-speed pipe without the problems listed above.

### SUMMARY

One embodiment of the present invention provides a system that facilitates managing network data traffic for multiple network services. During operation, the system receives flow rules for network data traffic from multiple network services, wherein the flow rules can possibly conflict. Next, the system collapses the flow rules from the multiple network services into a consistent set of flow rules in a low-level form that can be efficiently applied to a packet flow. The system subsequently installs the consistent set of flow rules into a flow enforcement device, which applies the consistent set of flow rules to a packet flow received from a high-speed network connection. In this way, the flow rules from the multiple network services can be simultaneously applied to packet flow, instead of being applied separately by each network service.

In a variation on this embodiment, each of the low-level flow rules specifies a filter that defines a class of packets in the packet flow, and an action that defines an operation to be applied to the class of packets.

In a variation on this embodiment, an operation defined by a low-level flow rule can include, but is not limited to: dropping a packet; gathering statistical information about the packet; controlling timer functions associated with the packet; modifying the packet with metadata; and passing the packet on. (Note that in general many other types of operations can be defined by low-level flow rules.)

In a variation on this embodiment, upon detecting a new flow at the flow enforcement device, the system creates a new rule for the new flow. The system also integrates the new rule into the consistent set of flow rules installed in the flow enforcement device, so that the flow enforcement device can handle the new flow.

In a variation on this embodiment, the multiple network services can include, but is not limited to: a firewall service; a service level agreement monitoring service; a load balancing service; a transport matching service; a failover service; and a high availability service.

In a variation on this embodiment, upon receiving environment information from an environment agent, the system uses the environment information to update the consistent set of flow rules.

In a variation on this embodiment, upon receiving information from an application, the system uses the information to update the consistent set of flow rules.

### BRIEF DESCRIPTION OF THE FIGURES

FIG. 1 illustrates a pipeline containing management modules.

FIG. 2 illustrates a pipeline containing management modules with separate components for management and classification/dispatch in accordance with an embodiment of the present invention.

FIG. 3 illustrates a set of parallel pipelines containing management modules.

FIG. 4 illustrates an architecture that handles packet flows in accordance with an embodiment of the present invention.

FIG. 5 presents a more-detailed view of the flow manager architecture illustrated in FIG. 4 in accordance with an embodiment of the present invention.

FIG. 6 presents a flow chart illustrating the operation of the flow manager in accordance with an embodiment of the present invention.

FIG. 7 presents a flow chart illustrating how a new flow is handled in accordance with an embodiment of the present invention.

FIG. 8 presents a flow chart illustrating how environment information is used to update flow rules in accordance with an embodiment of the present invention.

FIG. 9 presents a flow chart illustrating how information from an application is used to update flow rules in accordance with an embodiment of the present invention.

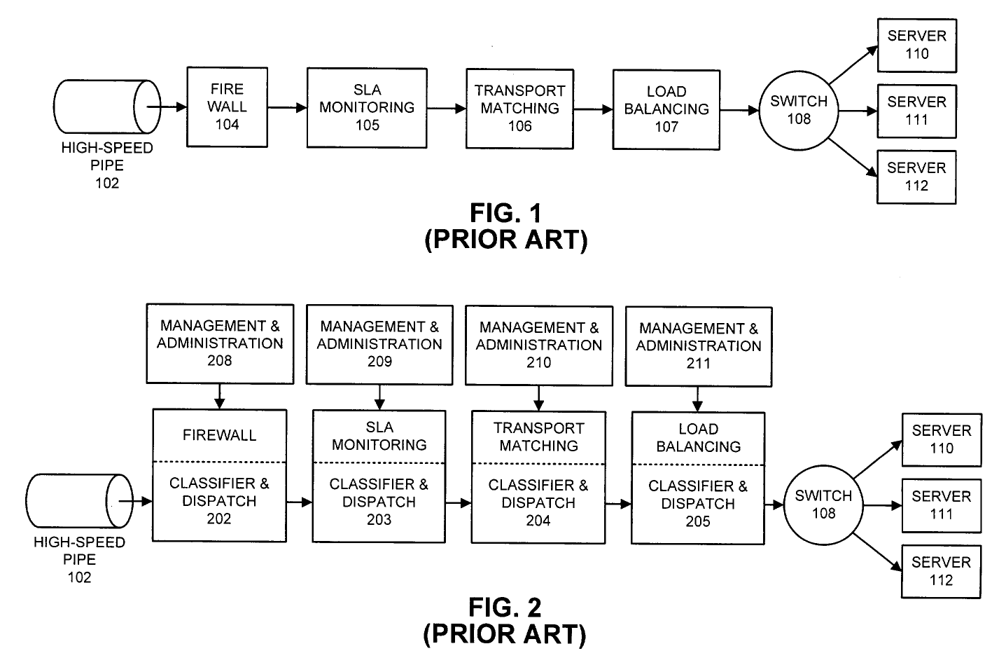

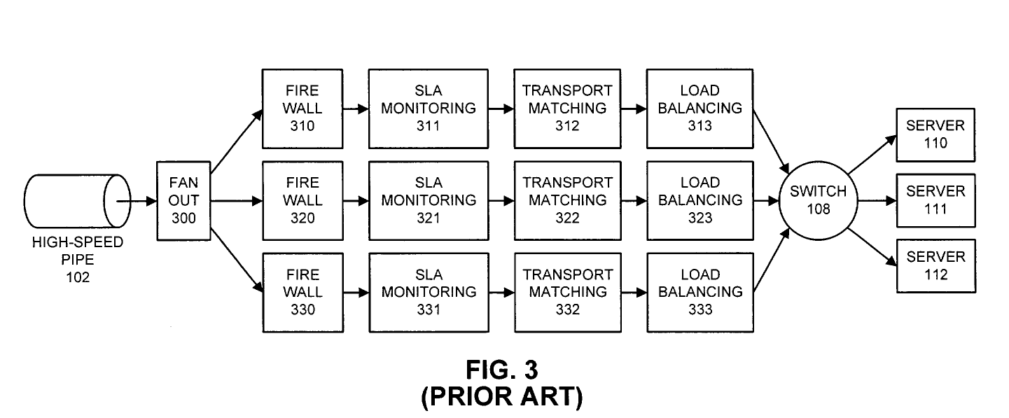

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Flow Manager Architecture

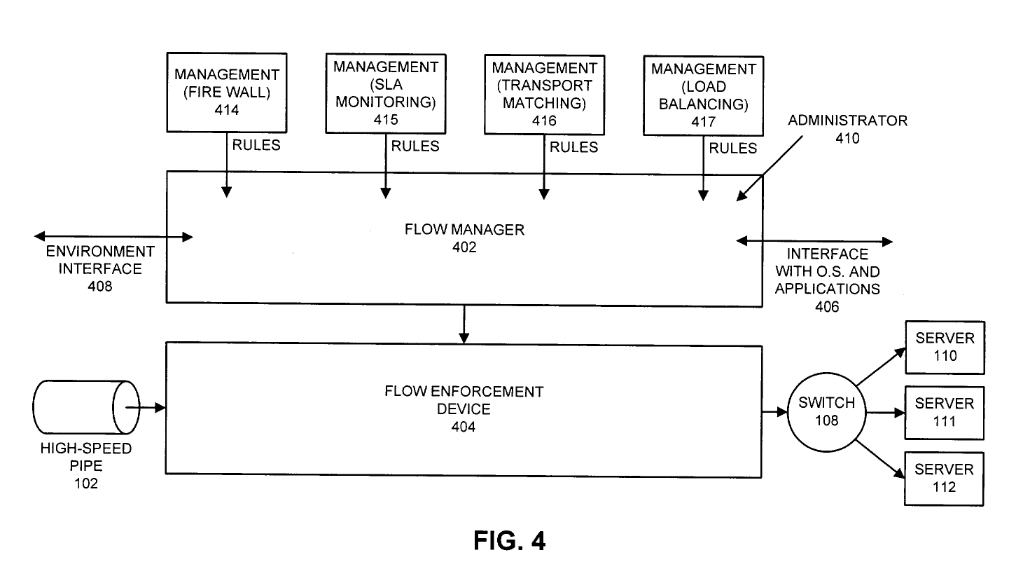

FIG. 4 illustrates an architecture that handles packet flows in accordance with an embodiment of the present invention. This architecture includes flow manger 402 and flow enforcement device 404. During operation, flow enforcement device 404 receives packets from high-speed pipe 102 and routes the packets to through switch 108 to servers 110-112. Flow enforcement device 404 can also perform simple operations on the packets, such as translating packet headers.

Flow manager 402 generates a consistent set of rules for flow enforcement device 404 based on rules received from various components. For example, FIG. 4 illustrates an exemplary set of components, including firewall management component 414, SLA monitoring component 415, transport matching management component 416 and load balancing management component 417. Note that this exemplary set of components is provided for purposes of illustration only. In general, the system can include many other different types of components. Also note that rules from different components can potentially conflict.

Firewall management component 414 provides various security features associated with firewall functions performed by the edge device. For example, firewall management component 414 can implement an access control policy that only allows specific packets to reach servers 110-112.

SLA monitoring component 415 provides various services associated with monitoring service level agreements for customers that make use of servers 110-112.

Transport matching management component 416 matches a network flow with an underlying transport protocol. Note that communications coming into a data center are typically TCP/IP traffic. Furthermore, the source of a communication assumes that the destination is speaking the same protocol. However, a data center may choose to use a different protocol within its own walls for reasons of efficiency or backward compatibility. For example, some companies are presently talking about using Infiniband (IB) within a server cluster. For this to work, some mechanism has to terminate the TCP flow and initiate an IB flow within the cluster. This process is known as “transport matching.”

Load balancing management component 417 routes packets to servers 1 10-1 12 in a manner that balances load between servers 110-112. For example, if one server is heavily loaded, load balancing management component 417 can route a new flow to a less loaded server.

Flow manager 402 can also receive input from other sources. (1) Flow manager 402 can receive commands from an administrator specifying, for example, how to route specific flows and how to prioritize network services. (2) Flow manager 402 can receive input from an environment interface 408 that communicates with a environment agents. (3) Flow manager can also receive input from another interface 406 that communicates with an operating system and applications running on servers 110-112.

Flow manager 402 considers these inputs and rules in creating a single consistent set of flow rules in a low-level form that can be used by flow enforcement device 404. In one embodiment of the present invention, each of the low-level flow rules specifies a filter that defines a class of packets in the packet flow as well as an action that defines an operation to be applied to the class of packets. In this way, the filter can be used to locate packets that the flow rule applies to, and the action can be used to apply the operation to the identified packets.

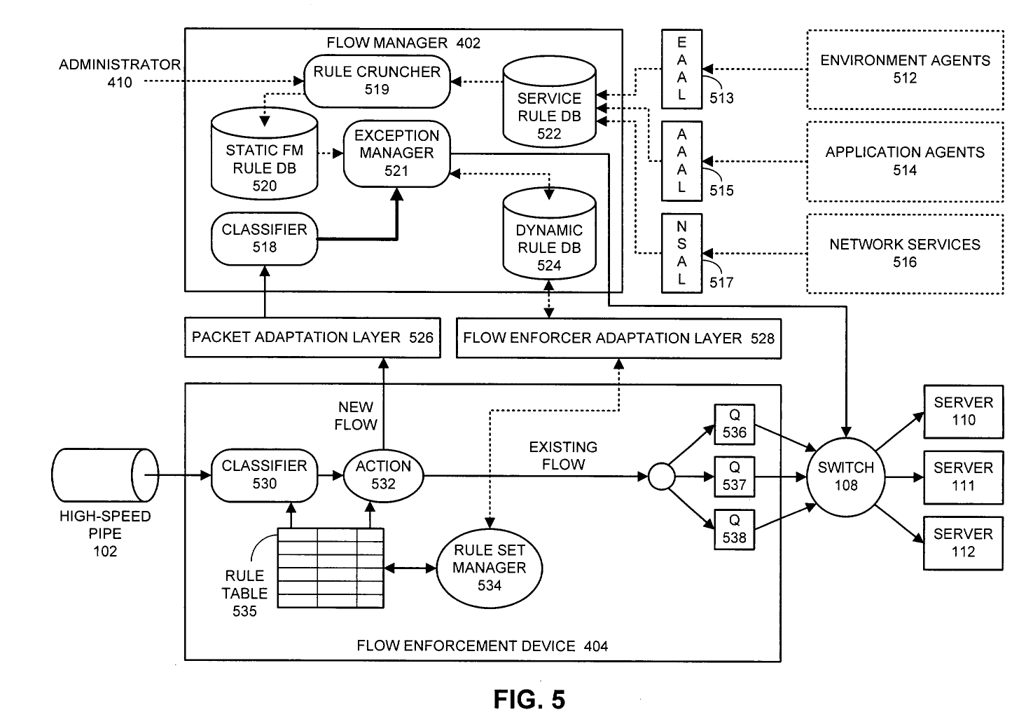

FIG. 5 presents a more-detailed view of the flow manager architecture illustrated in FIG. 4 in accordance with an embodiment of the present invention. In FIG. 5, flow manager 402 receives inputs from environment agents 512 through environment agent adaptation layer (EAAL) 513. Environment agents 512 can for example provide information on the time of day, which allows rules to change depending upon the time of day. Environment agents 512 can also provide information on current network traffic, which may, for example, indicate that a denial of service attack is taking place.

Flow manager 402 also receives input from application agents 514 through application agent adaptation layer (AAAL) 515. Application agents 514 can provide information from an operating system or application running on servers 110-112. For example, an application can indicate that a customer has provided a credit card number to a web site, thereby indicating that the customer is a paying client, as opposed to someone who is merely browsing through the web site. This causes flow manager 402 to give network flows from the customer a higher priority.

Flow manager 402 also receives rules from various network services 516 through network service adaptation layer 517. As in FIG. 4, these network services can include management component 414, SLA monitoring component 415, transport matching management component 416 and load balancing management component 417.

Flow manager 402 uses inputs received from environment agents 512, application agents 514 and network services 516 to create and/or modify rules in service rule database 522.

Rule cruncher 519 combines rules from service rule database 522 and input from administrator 410 to produce rules that are stored in static flow manager (FM) rule database 520. These rules are subsequently fed through exception manager 521, which generates rules for new flows. The resulting rules are stored in dynamic rule database 524.

Flow enforcement device 404 includes rule set manager 534, which retrieves rules through flow enforcement adaptation layer 528 and uses the rules to populate rule table 535. Flow enforcement device 404 also includes classifier 530, which uses filters from rule table 535 to identify packets associated with specific rules.

Once packets are identified, specified actions are applied to the packets by action module 532. In doing so, action module 532 feeds flows into a number of queues 536-537, which feed into switch 108. Action module 532 can perform a number of actions on packets, such as, dropping packets, translating headers of packets, and inserting metadata into packets.

If action module 532 encounters a packet that does not match any of the existing filters, the packet is part of a new flow. Information associated with the packet feeds through packet adaptation layer 526 into classifier 518 flow manager 402. The output of classifier 518 feeds into exception manager 521, which generates rules for the new flow. These rules are stored in dynamic rule database 524 and are used to populate rule table 535 within flow enforcement device 404.

Operation of Flow Manager

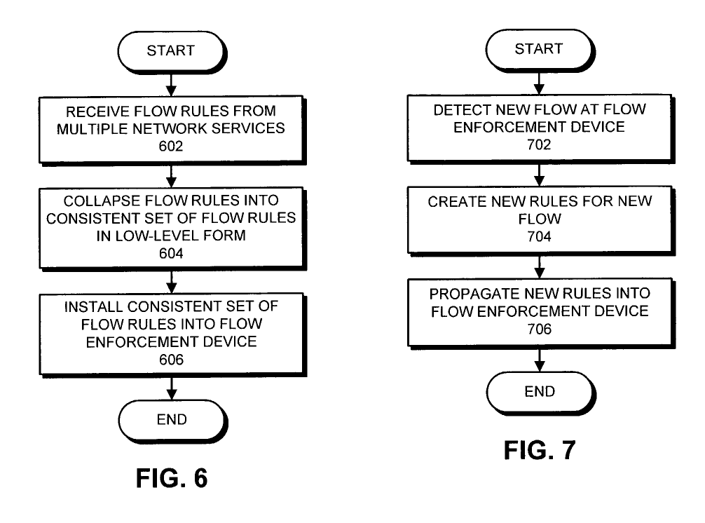

FIG. 6 presents a flow chart illustrating the operation of flow manager 402 in accordance with an embodiment of the present invention. Upon receiving rules from multiple network service (step 602) (as well as input from environment agents 512, application agents 514 and administrator 410), rule cruncher 519 collapses the rules into a consistent set of flow rules in a low-level form suitable for use by flow enforcement device 404 (step 604).

In one embodiment of the present invention, the task of collapsing the rules involves identifying conflicts between rules and assigning different priorities to the conflicting rules. This allows higher priority rules to be applied before lower priority rules. For example, firewall rules can be given a higher priority than load balancing rules, because the firewall rules ensure security of the datacenter, whereas the load balancing rules merely improve server utilization.

The resulting rules are stored into rule table 535 within flow enforcement device 404 (step 606), and are subsequently used in processing packets received through high-bandwidth pipe 102.

New Flow

FIG. 7 presents a flow chart illustrating how a new flow is handled in accordance with an embodiment of the present invention. The process starts when a new flow is detected at flow enforcement device 404 (step 702). This detection can occur, for example, when a received packet does not match any existing templates in rule table 535. This new flow is communicated to classifier 518 within flow manager 402. The output of classifier 518 is used by exception manager 521 to produce new rules for the new flow (step 704). These new rules are then integrated into the consistent set of rules stored in dynamic rule database 524, which allows them to be propagated into rule table 525 within flow enforcement device 404 (step 706).

Updating Flow Rules

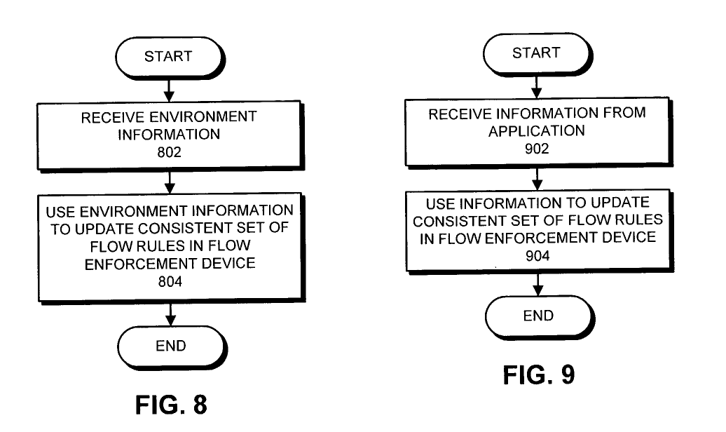

FIG. 8 presents a flow chart illustrating how environment information is used to update flow rules in accordance with an embodiment of the present invention. Upon receiving environment information from environment agents 512 (step 802), the system uses the environment information to update the flow rules in rule table 535 within flow enforcement device 404 (step 804). This involves updating rules in service rule database 522, static flow manager rule database 520 and dynamic rule database 524 as is described above with reference to FIG. 5.

FIG. 9 presents a flow chart illustrating how information from an application is used to update flow rules in accordance with an embodiment of the present invention. Upon receiving new information from an application or operating system from application agents 514 (step 902), the system uses the information to update the flow rules in rule table 535 within flow enforcement device 404 (step 904). As above, this involves updating rules in service rule database 522, static flow manager rule database 520 and dynamic rule database 524.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for simultaneously managing network data traffic for multiple network services, comprising:
receiving flow rules for network data traffic from multiple network services, wherein the flow rules from the multiple network services can possibly conflict; and
collapsing the flow rules from the multiple network services into a consistent set of flow rules in a low-level form that can be efficiently applied to a packet flow; and
installing the consistent set of flow rules into a flow enforcement device, which applies the consistent set of flow rules to a packet flow received from a high-speed network connection;
whereby the flow rules from the multiple network services can be simultaneously applied to packet flow, instead of being applied separately by each network service.

2. The method of claim 1, wherein each of the low-level flow rules specifies:
a filter that defines a class of packets in the packet flow; and
an action that defines an operation to be applied to the class of packets.

3. The method of claim 2, wherein an operation defined by a low-level flow rule can include:
dropping a packet;
gathering statistical information about the packet;
controlling timer functions associated with the packet;
modifying the packet; and
passing the packet on.

4. The method of claim 1, further comprising:
detecting a new flow at the flow enforcement device; and
in response to detecting the new flow,
creating a new rule for the new flow, and
integrating the new rule into the consistent set of flow rules installed in the flow enforcement device, so that the flow enforcement device can handle the new flow.

5. The method of claim 1, wherein the multiple network services can include:
a firewall service;
a service level agreement monitoring service;
a load balancing service;
a transport matching service;
a failover service; and
a high availability service.

6. The method of claim 1, further comprising:
receiving environment information from an environment agent; and
using the environment information to update the consistent set of flow rules.

7. The method of claim 1, further comprising:
receiving information from an application; and
using the information to update the consistent set of flow rules.

8. The method of claim 1, wherein collapsing the flow rules from the multiple network services into a consistent set of flow rules involves prioritizing the flow rules received from the multiple network services.

9. A computer-readable storage medium storing instructions that when executed by a computer cause the computer to perform a method for simultaneously managing network data traffic for multiple network services, the method comprising:
receiving flow rules for network data traffic from multiple network services, wherein the flow rules from the multiple network services can possibly conflict; and
collapsing the flow rules from the multiple network services into a consistent set of flow rules in a low-level form that can be efficiently applied to a packet flow; and
installing the consistent set of flow rules into a flow enforcement device, which applies the consistent set of flow rules to a packet flow received from a high-speed network connection;
whereby the flow rules from the multiple network services can be simultaneously applied to packet flow, instead of being applied separately by each network service.

10. The computer-readable storage medium of claim 9, wherein each of the low-level flow rules specifies:
a filter that defines a class of packets in the packet flow; and
an action that defines an operation to be applied to the class of packets.

11. The computer-readable storage medium of claim 10, wherein an operation defined by a low-level flow rule can include:
dropping a packet;
gathering statistical information about the packet;
controlling timer functions associated with the packet;
modifying the packet; and
passing the packet on.

12. The computer-readable storage medium of claim 9, wherein the method further comprises:
detecting a new flow at the flow enforcement device; and
in response to detecting the new flow,
creating a new rule for the new flow, and
integrating the new rule into the consistent set of flow rules installed in the flow enforcement device, so that the flow enforcement device can handle the new flow.

13. The computer-readable storage medium of claim 9, wherein the multiple network services can include:
a firewall service;
a service level agreement monitoring service;
a load balancing service;
a transport matching service;
a failover service; and
a high availability service.

14. The computer-readable storage medium of claim 9, wherein the method further comprises:
receiving environment information from an environment agent; and
using the environment information to update the consistent set of flow rules.

15. The computer-readable storage medium of claim 9, wherein the method further comprises:
receiving information from an application; and
using the information to update the consistent set of flow rules.

16. The computer-readable storage medium of claim 9, wherein collapsing the flow rules from the multiple network services into a consistent set of flow rules involves prioritizing the flow rules received from the multiple network services.

17. An apparatus that simultaneously manages network data traffic for multiple network services, comprising:
a rule receiving mechanism configured to receive flow rules for network data traffic from multiple network services, wherein the flow rules from the multiple network services can possibly conflict; and
a collapsing mechanism configured to collapse the flow rules from the multiple network services into a consistent set of flow rules in a low-level form that can be efficiently applied to a packet flow; and
an installing mechanism configured to install the consistent set of flow rules into a flow enforcement device, which applies the consistent set of flow rules to a packet flow received from a high-speed network connection;
whereby the flow rules from the multiple network services can be simultaneously applied to packet flow, instead of being applied separately by each network service.

18. The apparatus of claim 17, wherein each of the low-level flow rules specifies:
a filter that defines a class of packets in the packet flow; and
an action that defines an operation to be applied to the class of packets.

19. The apparatus of claim 18, wherein an operation defined by a low-level flow rule can include:
dropping a packet;
gathering statistical information about the packet;
controlling timer functions associated with the packet;
modifying the packet; and
passing the packet on.

20. The apparatus of claim 17, further comprising:
a flow detecting mechanism within the flow enforcement device configured to detect a new flow; and
a rule updating mechanism configured to,
create a new rule for the new flow, and to
integrate the new rule into the consistent set of flow rules installed in the flow enforcement device, so that the flow enforcement device can handle the new flow.

21. The apparatus of claim 17, wherein the multiple network services can include:
a firewall service;
a service level agreement monitoring service;
a load balancing service;
a transport matching service;
a failover service; and
a high availability service.

22. The apparatus of claim 17, further comprising a rule updating mechanism configured to:
receive environment information from an environment agent; and to
use the environment information to update the consistent set of flow rules.

23. The apparatus of claim 17, further comprising a rule updating mechanism configured to:
receive information from an application; and to
use the information to update the consistent set of flow rules.

24. The apparatus of claim 17, wherein the collapsing mechanism is configured to prioritize the flow rules received from the multiple network services.
